(19) United States
(12) Patent Application Publication
(10) Pub. No.: US 2023/0379890 A1
(43) Pub. Date: Nov. 23, 2023

(54) RESOURCE REQUEST FOR COMMUNICATION AMONG LOCAL DEVICES

(71) Applicant: MEDIATEK INC., Hsinchu (TW)

(72) Inventor: Lung-Sheng Tsai, Hsinchu (TW)

(21) Appl. No.: 18/137,530

(22) Filed: Apr. 21, 2023

Related U.S. Application Data
(60) Provisional application No. 63/344,648, filed on May 23, 2022.

(51) Int. Cl. H04W 72/044; H04W 52/36; H04W 72/542

(52) U.S. Cl. CPC H04W 72/044; H04W 52/367; H04W 72/542; H04B 7/0413

(57) ABSTRACT

In an aspect of the disclosure, a method, a computer-readable medium, and an apparatus are provided. The apparatus may be a UE. The UE receives an allocation of time-frequency resources from a base station for local communications between the UE and one or more repeaters, as well as a maximum transmission power for these local communications. Furthermore, the UE transmits data signals to the base station or receives data signals from the base station through the allocated time-frequency resources for local communications.

### CROSS-REFERENCE TO RELATED APPLICATION(S)

This application claims the benefits of U.S. Provisional Application Ser. No. 63/344,648, entitled “RESOURCE REQUEST FOR COMMUNICATION AMONG LOCAL DEVICES” and filed on May 23, 2022. The content of the application above is expressly incorporated by reference herein in its entirety.

### BACKGROUND

### Field

The present disclosure relates generally to communication systems, and more particularly, to techniques of forming distributed MIMO receivers.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives an allocation of time-frequency resources from a base station for local communications between the UE and one or more repeaters, as well as a maximum transmission power for these local communications. Furthermore, the UE transmits data signals to the base station or receives data signals from the base station through the allocated time-frequency resources for local communications.

In another aspect of the disclosure, a method, a computer-readable medium, and an apparatus are provided. The apparatus may be a base station. The base station receives a capability indicator from a UE, which indicates the maximum number of L₁ spatial layers that the UE can support with one or more repeaters through local communications, where L₁ is a positive integer. The base station allocates time-frequency resources for the local communications between the UE and the one or more repeaters. The base station determines a multiple-input multiple-output (MIMO) configuration that supports at most L₂ spatial layers for the UE, based on the received capability indicator indicating the maximum number of L₁ spatial layers, where L₂ is a positive integer and no greater than L₁. The base station transmits at most L₂ layers of data signals to the UE for downlink (DL) or receives at most L₂ layers of data signals from the UE for uplink (UL).

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating communications between a base station to a UE.

FIG. 8 is a diagram illustrating communications between the base station and the UE via one or more repeaters.

FIG. 9 is a flow chart of a method (process) for requesting resources for local communications.

FIG. 10 is a flow chart 1000 of a method (process) for allocating resources for local communications.

FIG. 11 is a diagram illustrating an example of a hardware implementation for an apparatus employing a processing system.

FIG. 12 is a diagram illustrating an example of a hardware implementation for another apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

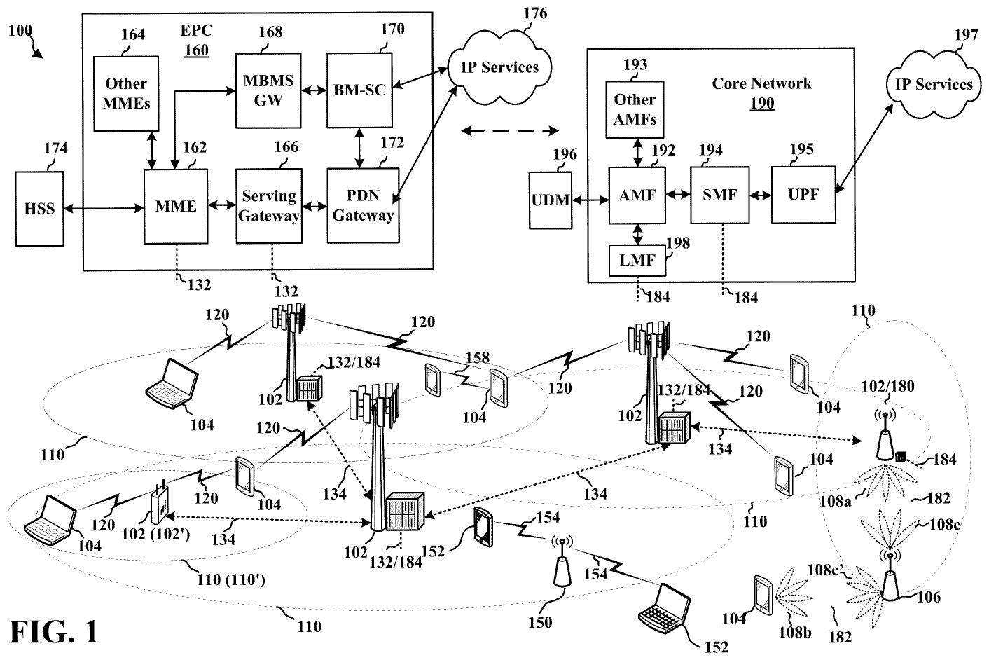

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to X MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

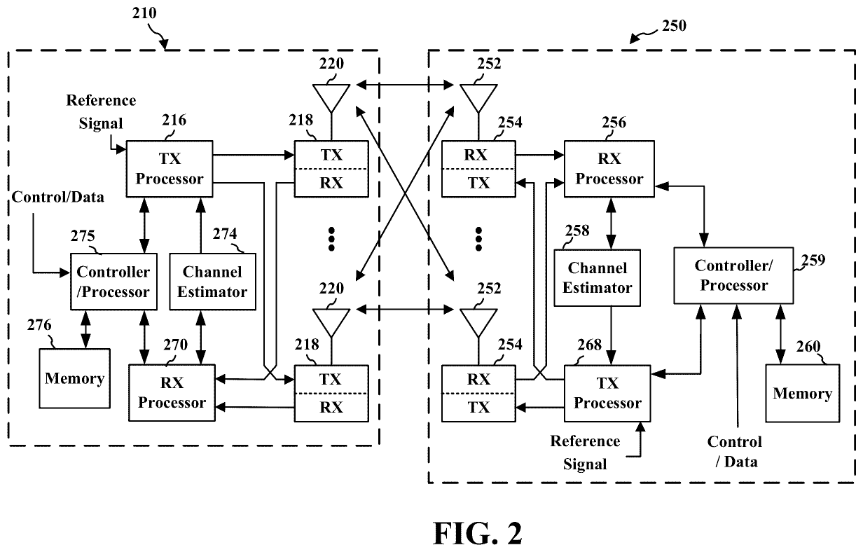

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

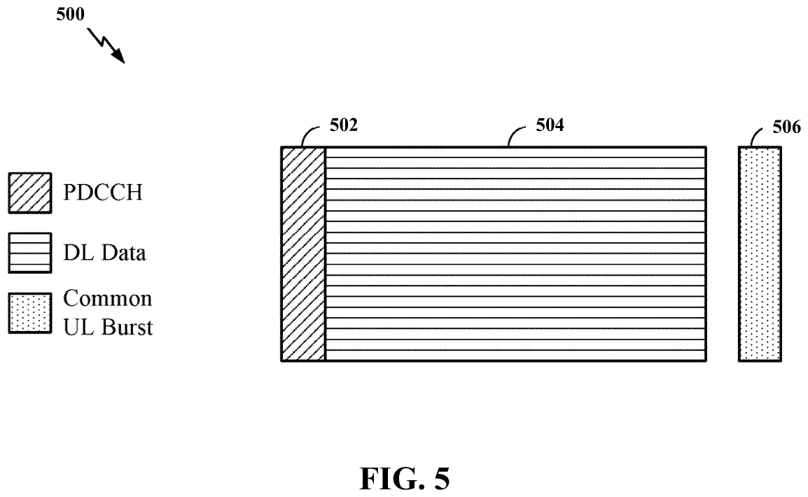

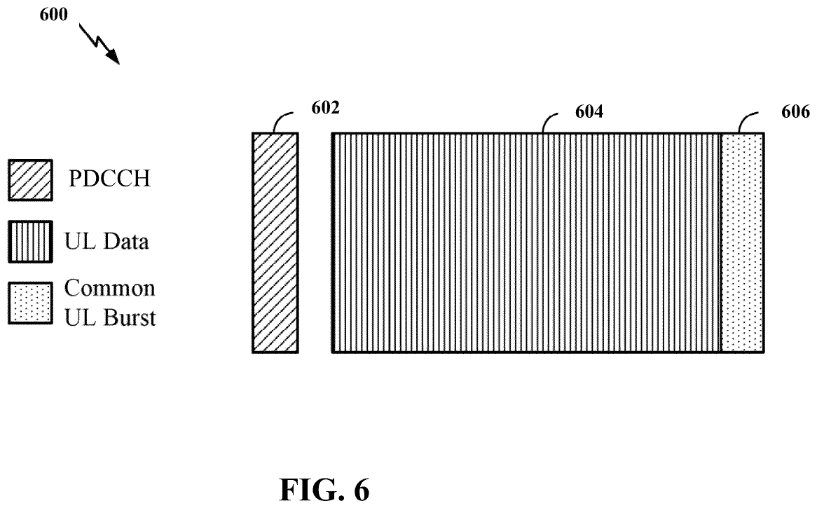

A single component carrier bandwidth of 100 MHz may be supported. In one example, NR resource blocks (RBs) may span 12 sub-carriers for each RB with a subcarrier spacing (SCS) of 60 kHz over a 0.25 ms duration or a SCS of 30 kHz over a 0.5 ms duration (similarly, 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

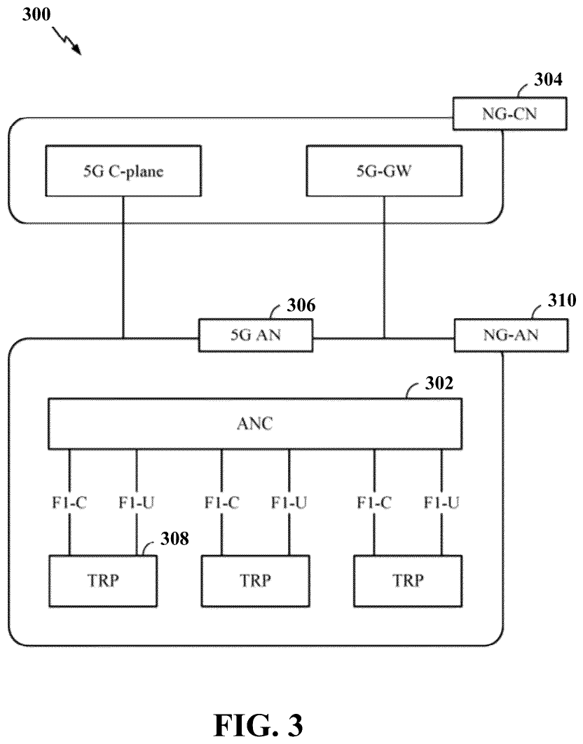

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

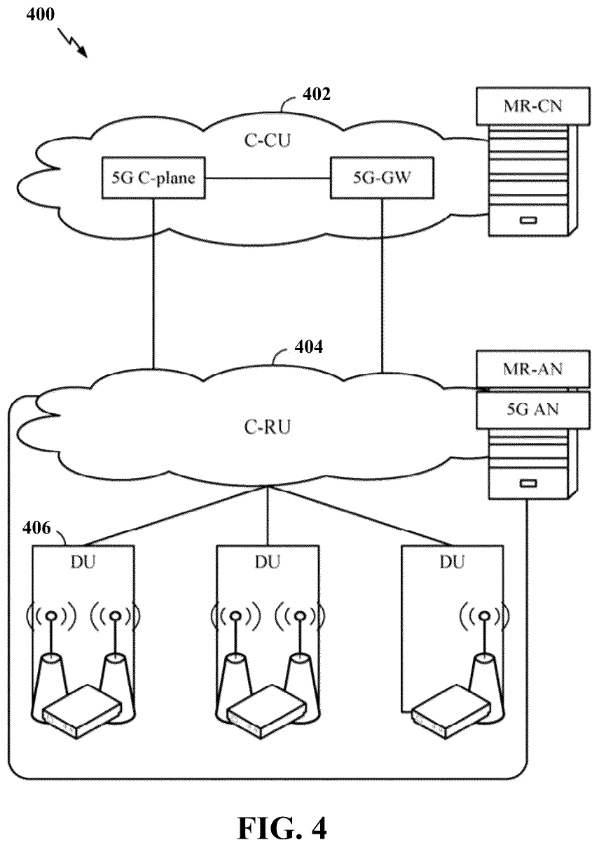

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UET) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

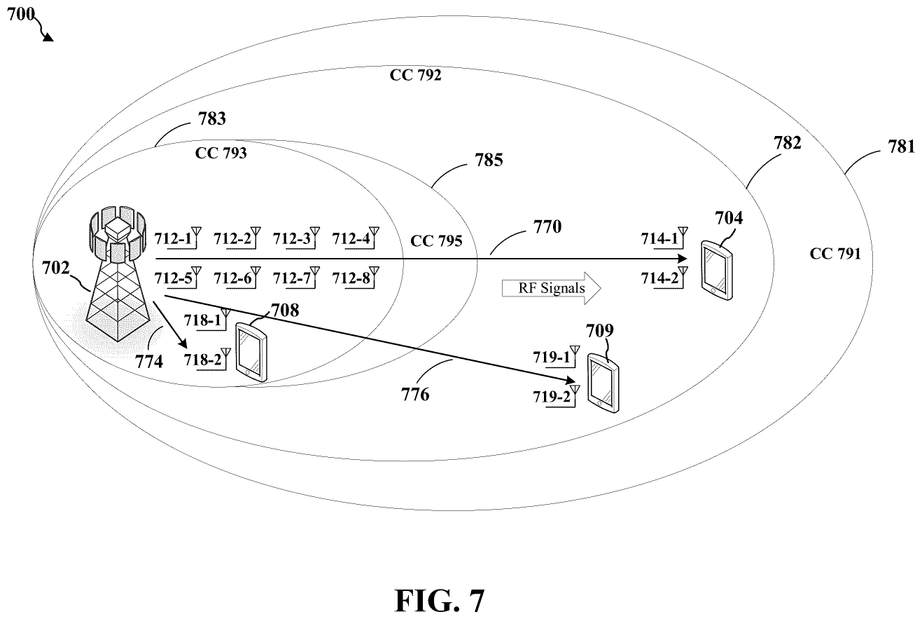

FIG. 7 is a diagram 700 illustrating communications between a base station to a UE. In this example, a base station 702 established component carriers (CCs) 791, 792, 793, 795, which can provide communication coverage for geographic coverage areas 781, 782, 783 and 785, respectively. Further, a UE 704 and a UE 709 are located outside of the coverage area 783, and a UE 708 is located in the coverage area 783. In this example, the base station 702 has 8 antennas 712-1, 712-2, . . . 712-8. The UE 704 has 2 antennas 714-1, 714-2; the UE 708 has 2 antennas 718-1, 718-2; and the UE 709 has 2 antennas 719-1, 719-2. In certain configurations, the same physical antenna may function for more than one CC. Further, the aforementioned antennas of the base station 702 and the UEs 704, 708, 709 can serve as both transmission and reception antennas. In one configuration, on the downlink, the base station 702 may generate 2 layers baseband data signals directed to a single UE (e.g., the UE 704). The 2 layers baseband data signals can be mapped to two or more of the antennas 712-1, 712-2, . . . 712-8. Similarly, on the uplink, a UE (e.g., the UE 704) may generate 2 layers baseband data signals directed to the base station 702. The 2 layers baseband data signals can be mapped to one or two of the antennas 714-1, 714-2.

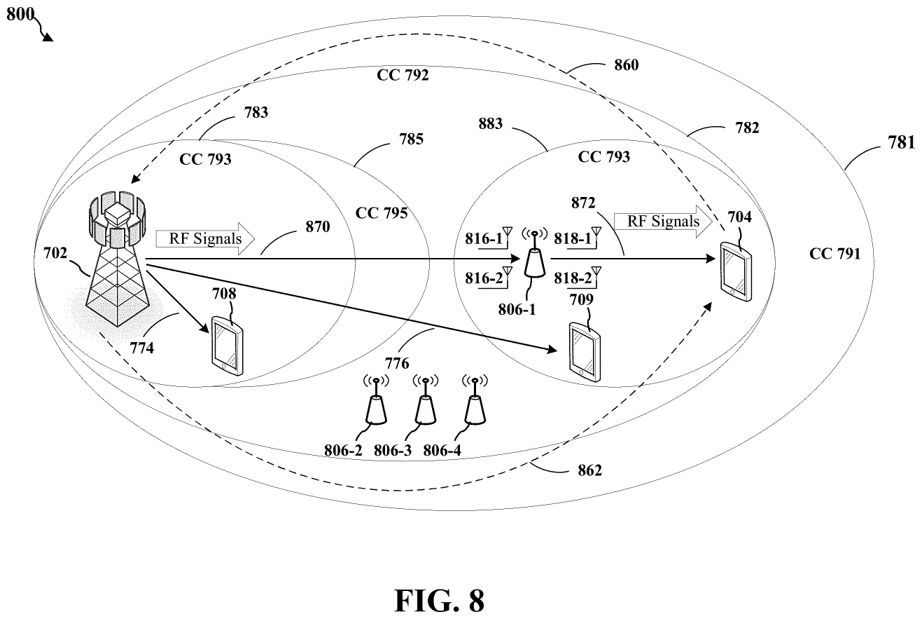

FIG. 8 is a diagram 800 illustrating communications between the base station 702 and the UE 704 via one or more repeaters. More specifically, repeaters 806-1 . . . 806-K are placed between the base station 702 and the UE 704. The UE 704 may be considered as a master device. The repeaters 806-1 . . . 806-K may be considered as slave devices. The repeaters 806-1 . . . 806-K may be UEs, wireless routers, or other wireless devices that performs the functions infra. In this example, K is 4. The repeaters 806-1 . . . 806-K are located within the coverage area 781 of the CC 791 and the coverage area 782 of the CC 792, but is outside of the coverage area 783 of the CC 793. Each of the repeaters 806-1 . . . 806-K has antennas 816-1, 816-2, 818-1, 818-2. In certain configurations, the same physical antenna may function as a reception antenna and a transmission antenna.

On the downlink, the base station 702 transmits RF signals at the antennas 712-1, 712-2, . . . 712-8. Each of the repeaters 806-1 . . . 806-K receives the RF signals, and amplifies and forwards the received RF signals. Using the repeater 806-1 as an example, each of the reception antennas 816-1, 816-2 of the repeater 806-1 may receive RF signals transmitted from the antennas 712-1, 712-2, . . . 712-8 of the base station 702 on the frequency band f₁ through a channel 870 that may utilize the CC 791. As described infra, the base station may allocate the CC 793 (or other resources) for communications between repeaters 806-1 . . . 806-K and the UE 704. The CC 793 has a coverage area 883. Accordingly, the repeater 806-1 can amplify and forward the received RF signals through a channel 872 that may utilize the CC 793.

Further, on the downlink, the repeater 806-1 shifts the frequency of the RF carrier from the frequency band f₁ to a frequency band f₂ and transmits RF signals on the frequency band f₂ at the 2 antennas 818-1, 818-2. Each frequency band is an interval in frequency domain. In particular, the repeater 806-1 may be a frequency translating repeater. The repeater 806-1 may also be a time delaying repeater, which receive RF signals and then re-transmit the received RF signals after some time delay.

The baseband signals carried on the RF carrier of the frequency band f₁ from the base station 702 may have a first subcarrier spacing (e.g., 30 kHz). In a first configuration, the baseband signals carried on the RF carrier of the frequency band f₂ from the repeaters 806-1 . . . 806-K may have the same first subcarrier spacing (e.g., 30 kHz). In a second configuration, the baseband signals carried on the RF carrier of the frequency band f₂ from the repeaters 806-1 . . . 806-K may have a second subcarrier spacing (e.g., 120 kHz). Accordingly, the UE 704 receives, on the frequency band f₂, the RF signals transmitted from the repeaters 806-1 . . . 806-K.

Similarly, on the uplink, the repeater 806-1 shifts the frequency of the RF carrier from the frequency band f₂ to a frequency band f₁ and transmits RF signals on the frequency band f₁ at the 2 transmission antennas 816-1, 816-2.

In general, multiple distributed low-rank mobile terminals (MTs) or wireless devices can form a high-rank MIMO receiver MT. In one scenario, there are one master MT (e.g., the UE 704) and K slave MTs (e.g., the repeaters 806-1 . . . 806-K), which are represented as MTk (1≤k≤K)). L layers of data signals are transmitted from the base station 702. The value of L is upper bounded by the number of transmission antennas at the transmitter and the total number of receive antennas of all the slave MTs and the master MT; L may be greater than the number of receive antennas at the master MT. A given slave MTk amplifies and forwards signals received from the transmitter on a frequency band f₁. The MTk translates the amplified/forwarded signals to another frequency band f_{2,k} and transmits the translated signals to the master MT on the frequency band f_{2,k}.

In general, the low-rank UE 704 and the low-rank repeaters 806-1 . . . 806-K can form a high-rank MIMO receiver mobile terminal (MT). The communications between the UE 704 and the repeaters 806-1 . . . 806-K may be referred to as local communications. Further, in this example, the base station 702 has N_{T} transmission antennas. As described supra, there are total K repeaters 806-1 . . . 806-K placed in between the base station 702 and the UE 704. Each repeater has M reception antennas/transmission antennas. The baseband signals correspond to L spatial layers, where L is a positive integer and can be at most equal to the total number of antennas of the repeaters, i.e., K*M. In this example, N_{T}=8, K=4, M=2, and L is upper bounded by R=K*M=8.

Prior to establishing communications with the repeaters 806-1 . . . 806-K, the UE 704 needs to inform the base station 702 of the value of R and send a request to the base station 702 for allocating resources for the local communications. Accordingly, the base station 702 needs to determine resources that can be used for communications between the UE 704 and the repeaters 806-1 . . . 806-K based on certain criteria as described infra.

In particular, the base station 702 may ask devices that are connected to the base station 702 to submit measurement reports for a first set of CCs, which are CCs that are supported by the base station 702, in order to estimate the interference issue if the CCs are reused by local communication. The measurement report may be based on L1 or L3 measurement. In this example, the first set of CCs includes the CC 791, the CC 792, and the CC 793. The base station transmits reference signals on the CC 791, CC 792, and CC 793. The base station 702 requests the UE 704 and the repeaters 806-1 . . . 806-K to measure the reference signals on the CC 791, the CC 792, and the CC 793, and to submit corresponding measurement reports.

In this example, the UE 704 and the repeaters 806-1 . . . 806-K are located outside of the coverage area 783 of the CC 793 and may not be able to detect and measure the reference signals on the CC 793. The measurement reports for the reference signals on the CC 793 from the UE 704 and the repeaters 806-1 . . . 806-K may indicate that the received reference signals are weak. Accordingly, based on the report, the base station 702 determines that the CC 793 should not be activated for direct communications between the base station 702 and the UE 704. That is, the base station 702 does not transmit RF signals on the CC 793 to the UE 704. Thus, the base station 702 can determine that the CC 793 is a candidate resource for communications among the UE 704 and the repeaters 806-1 . . . 806-K.

Furthermore, the UE 704 may report to the base station 702 a maximum number of spatial layers (L₁) that the UE can support with the repeaters 806-1 . . . 806-K through local communications. Based on the received capability indicating the maximum number of L₁ spatial layers, the base station 702 can determine a multiple-input multiple-output (MIMO) configuration supporting at most L₂ spatial layers for the UE, where L₂ is a positive integer and no greater than L₁. The base station 702 can then transmit at most L₂ layers of data signals to the UE for downlink (DL) or receive at most L₂ layers of data signals from the UE for uplink (UL).

In certain configurations, the base station 702 may request the UE 704 and the repeaters 806-1 . . . 806-K to transmit reference signals (e.g., sounding reference signals) to the base station 702 on the CC 791, CC 792 and CC 793. In some scenarios, if the base station 702 cannot detect any reference signal or the received reference signals are weak (e.g., below a predetermined threshold) on a particular CC (e.g., the CC 793), the base station 702 can determine that local communications on that particular CC do not interfere the with communications between the base station 702 and other devices on the same particular CC. Accordingly, the base station 702 can determine that the particular CC (e.g., the CC 793) is a candidate resource for communications among the UE 704 and the repeaters 806-1 . . . 806-K.

In some scenarios, the base station 702 may detect that the reference signals from the UE 704 and the repeaters 806-1 . . . 806-K are strong (e.g., above a threshold) on a particular CC (e.g., the CC 792). Based on the reference signals, the base station 702 can further determine the direction of the UE 704 and the repeaters 806-1 . . . 806-K. Accordingly, the base station 702 can avoid using the particular CC (e.g., the CC 792) to communicate with UEs in the same or similar direction (e.g., the UE 704, the UE 709). Rather, the base station 702 only uses the particular CC (e.g., the CC 792) to communicate with UEs (e.g., the UE 708) not in the same or similar direction. As such, the base station 702 can determine that the particular CC (e.g., the CC 792) is a candidate resource for communications among the UE 704 and the repeaters 806-1 . . . 806-K.

In certain configurations, the base station 702 may not support communications on one or more CCs due to, for example, lack of hardware support. Such one or more CCs are referred to as a second set of CCs. In this example, the base station 702 does not support the transmission/reception (Tx/Rx) operations on a CC 795. That is, the CC 795 belongs to the second set of CCs. Local communications among the UE 704 and the repeaters 806-1 . . . 806-K on the CC 795 do not interfere with communications of the base station 702, which are not on the CC 795. Therefore, the base station 702 can determine that the second set of CCs (e.g., the CC 795) is a candidate resource for communications among the UE 704 and the repeaters 806-1 . . . 806-K.

Before the UE 704 and the repeaters 806-1 . . . 806-K start local communications, the base station 702 needs to allocate time/frequency resources to be used by the local communications. The local communications could be sidelink communications or for amplifying and forwarding without decoding data signal. The local communications are typically short range communications and can be achieved by using low transmission power. Usually, the local communications do not cause much interference to other devices. In certain configurations, the UE 704 may send a request 860 to the base station 702 through an RRC connected CC (e.g., the CC 791) for using resources/CCs. The request 860 may include information indicating which devices are to be included in the local communications. In this example, the UE 704 indicates that the repeaters 806-1 . . . 806-K will amplify and forward signals from the base station 702 to the UE 704.

Accordingly, the base station 702 can determine, as described supra, the interference levels caused by all the devices when using different CCs for local communications. For example, in some scenarios, the base station 702 does not detect any reference signals transmitted from the repeaters 806-1 . . . 806-K and the UE 704 on the CC 793 or the detected reference signals are weak. The base station 702 may not activate the CC 793 for direct communications between the base station 702 and the UE 704. The base station 702 may also determine that local communications on the CC 793 do not interfere with the communications between the base station 702 and other UEs (e.g., the UE 708). Accordingly, the base station 702 can allocate the CC 793 for the local communications among the UE 704 and the repeaters 806-1 . . . 806-K.

In some scenarios, the base station 702 detects reference signals from the repeaters 806-1 . . . 806-K and the UE 704 on the CC 892. The base station 702 configures the UEs (e.g., the UE 709) in the same/similar direction to communicate with the base station 702 using other CCs (e.g., the CC 791). The base station 702 may configure UEs (e.g., the UE 708) that are not in the same/similar direction as the UE 704 to also use the CC 793, as the local communications on the CC 793 do not interfere with the communication between the base station 702 and the UE 708 on the same CC.

In some scenarios, the base station 702 does not support or communicate the CC 795. Accordingly, the base station 702 can allocate the CC 795 for the local communications among the UE 704 and the repeaters 806-1 . . . 806-K, as local communications on the CC 795 do not cause interference to the base station 702.

In some scenarios, the base station 702 may determine that the communications between the base station and UE 708 or UE 709 on the CC 791 are robust enough to tolerate the interference caused by the local communication. Further, the base station 702 can estimate interferences caused by the local communications of the UE 704, and then compensate the interferences at the base station 702, the UE 708, or the UE 709.

Through the processes described supra, the base station 702 determines a third set of CCs that can be used for the local communications of the UE 704. The third set of CCs are selected from the first set of CCs (e.g., the CC 791, the CC 792 and the CC 793) or from the second set of CCs (e.g., the CC 795). The base station 702 may determine the time/frequency resources to be reused for the local communications of the UE 704 based on (1) that the time/frequency resources on the third set of CCs are not activated or allocated by the base station 702 for local communication among other devices, or (2) that the time/frequency resources on the third set of CCs are robust enough to tolerate co-channel interference caused by reusing the time/frequency resources.

Subsequently, the base station 702 may send admission response 862 to the UE 704 through the RRC connected CC 891. The admission response 862 indicates the time/frequency resources allocated for the local communications among the UE 704 and the repeaters 806-1 . . . 806-K. The admission response 862 may also indicate the maximum transmission power for the local communications.

In this example, the base station 702 sends the admission response 862 to the UE 704 for reusing CC 793 for the local communication. The admission response includes the spectrum information of the CC 793 or the allocated time-frequency resources on CC 793 and an indication of the maximum transmission power for the local communication so that the interference does not exceed a specified value. After the UE 704 receives the admission response 862, the UE 704 informs the repeaters 806-1 . . . 806-K regarding the allocated time-frequency resources and maximum transmission power for the local communications. Furthermore, the UE 704 may inform the repeaters 806-1 . . . 806-K the start time point of the local communications. The UE 704 may also inform the base station 702 that the local communication links have been established among the UE 704 and the repeaters 806-1 . . . 806-K. Accordingly, the base station 702 may start transmitting higher rank data signals to the UE 704 utilizing the local communications.

As described supra, the UE 704 needs to report to the base station 702 the maximum number of spatial layers L that the UE 704 can support with the repeaters 806-1 . . . 806-K through local communications. The base station 702 needs that information to set the configurations for the aggregated devices (i.e., the UE 704 and the repeaters 806-1 . . . 806-K). Whenever a component device of the aggregated devices changes, the maximum number of supporting spatial layers L may be changed, and the new value of L needs to be reported to the base station 702 for the new configuration. Network's configuration/reconfiguration/update should be based on the aggregated capability.

The present disclosure relates to techniques for improving the communication performance between a User Equipment (UE) and a base station in a cellular network. The techniques involve utilizing low-rank repeaters to form a high-rank MIMO system with the UE. The UE informs the base station of the maximum number of spatial layers L it can support with the repeaters through local communications. The base station then determines candidate time-frequency resources and allocates time-frequency resources for local communications among the UE and repeaters, considering interference levels and hardware support. The UE and repeaters measure and submit measurement reports for reference signals on candidate resources to help the base station in the allocation process. Once the resources are allocated, the UE establishes local communication links with the repeaters, and the base station transmits higher rank data signals to the UE, utilizing the local communications.

In an example described supra, the low-rank UE 704 and the low-rank repeaters 806-1 . . . 806-K form a high-rank MIMO system through local communications. The UE 704 informs the base station 702 of the maximum number of spatial layers L the UE 704 can support with the repeaters through local communications. The base station 702 estimates the interference levels and determines candidate resources for local communications based on the measurement reports submitted by the UE 704 and the repeaters 806-1 . . . 806-K. The base station 702 also considers whether certain CCs are supported by hardware of the base station 702 in the resource allocation process. Once the resources are allocated, the UE 704 informs the repeaters 806-1 . . . 806-K of the allocated time-frequency resources, maximum transmission power, and start time point for local communications. The UE 704 establishes local communication links with the repeaters, and the base station 702 transmits higher rank data signals to the UE 704 using the local communications. Network configuration, reconfiguration, or updates are based on the aggregated capability of the UE 704 and the repeaters 806-1 806-K.

These techniques provide several benefits, including improved communication performance between the UE and the base station, more efficient use of available time-frequency resources, and better interference management. By utilizing low-rank repeaters to form a high-rank MIMO system with the UE, the overall communication performance is enhanced, allowing for higher data rates and improved reliability. Additionally, by considering interference levels and hardware support in the allocation process, the base station can make more efficient use of available time-frequency resources, leading to better overall network performance. Furthermore, by measuring and submitting measurement reports for reference signals on candidate resources, the base station can better manage interference and allocate resources more effectively. Overall, these techniques provide a more robust and efficient communication system for both the UE and the base station, leading to improved user experience and network performance.

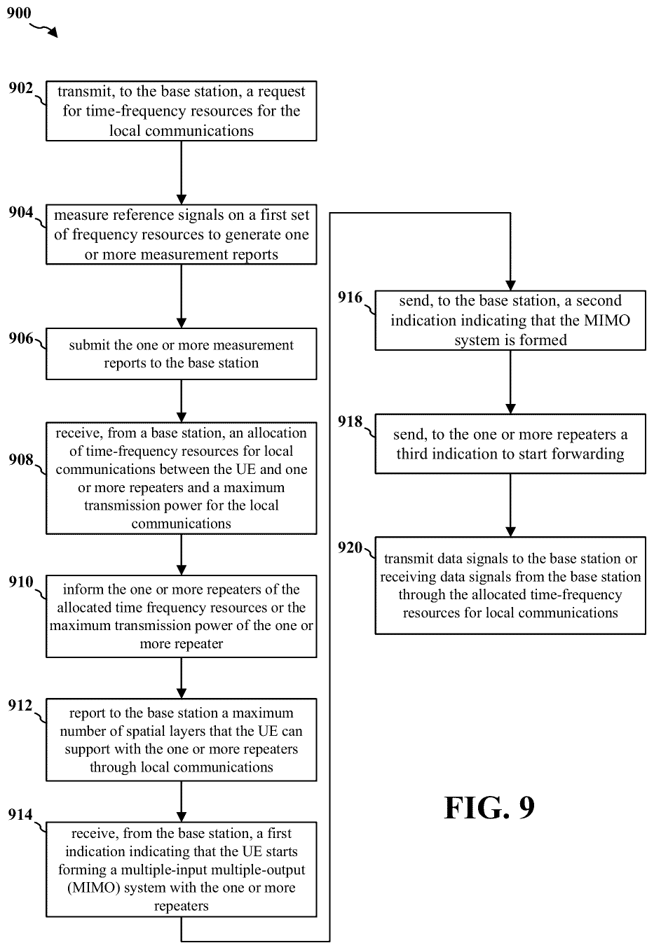

FIG. 9 is a flow chart 900 of a method (process) for requesting resources for local communications. The method may be performed by a UE (e.g., the UE 704). At operation 902, the UE transmits, to a base station, a request for time-frequency resources for local communications between the UE and one or more repeaters. In certain configurations, the one or more repeaters amplify received signals in first time-frequency resources and forward the amplified signals in second time-frequency resources, and the first time-frequency resources and the second time-frequency resources are non-overlapping in a frequency domain.

At operation 904, the UE measures reference signals on a first set of frequency resources to generate one or more measurement reports. The first set of frequency resources may include frequency resources not supported by the base station. At operation 906, the UE submits the one or more measurement reports to the base station. Based on these measurement reports, the base station determines the allocation of time-frequency resources for local communications between the UE and one or more repeaters.

At operation 908, the UE receives from the base station an allocation of time-frequency resources for the local communications, as well as a maximum transmission power for the local communications. The maximum transmission power for the local communications could be a maximum transmission power of an uplink transmission of the UE or a maximum transmission power of the one or more repeaters for downlink reception at the UE. At operation 910, the UE informs the one or more repeaters of the allocated time-frequency resources and the maximum transmission power for the local communications.

At operation 912, the UE reports to the base station a maximum number of spatial layers that the UE can support with the one or more repeaters through local communications. At operation 914, the UE receives, from the base station, a first indication indicating that the UE starts forming a multiple-input multiple-output (MIMO) system with the one or more repeaters. At operation 916, the UE sends, to the base station, a second indication indicating that the MIMO system is formed.

At operation 918, the UE sends, to the one or more repeaters, a third indication to start forwarding. At operation 920, the UE transmits data signals to the base station or receives data signals from the base station through the allocated time-frequency resources for local communications. The local communications may be sidelink communications or for amplifying and forwarding data signals between the UE and the base station.

The sequence of the operations detailed supra is provided as an example and should not be considered as restrictive. These operations may be reorganized based on different configurations. For instance, in certain configurations, operation 910 and operation 912 may be swapped. Similarly, operation 916 and operation 918 may be interchanged in certain configurations.

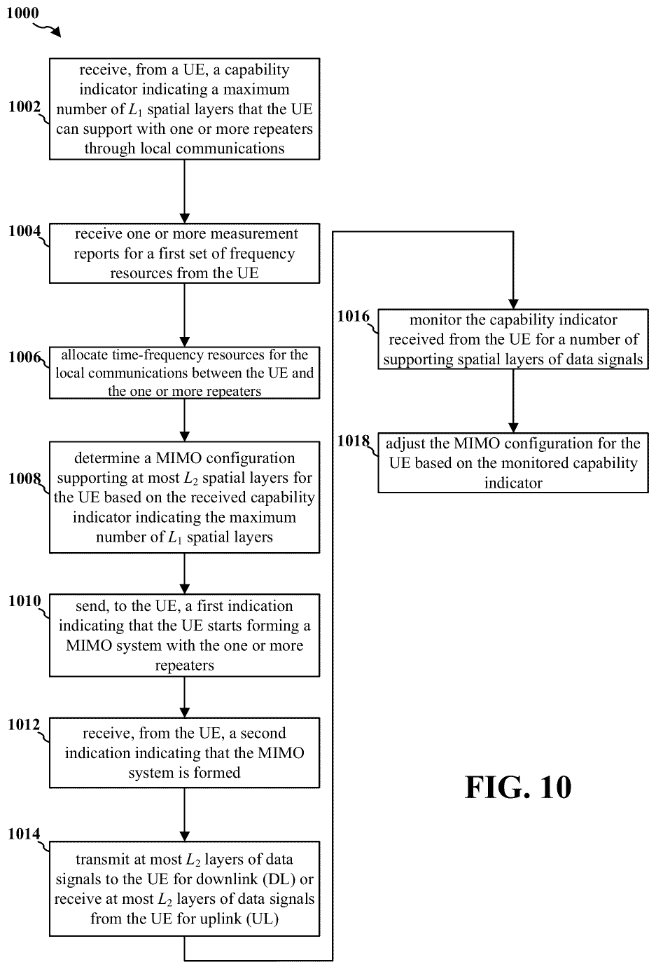

FIG. 10 is a flow chart 1000 of a method (process) for allocating resources for local communications. The method may be performed by a base station (e.g., the base station 702). At operation 1002, the base station receives a capability indicator from a UE. The capability indicator indicates the maximum number of L₁ spatial layers that the UE can support with one or more repeaters through local communications, with L₁ being a positive integer.

Next, at operation 1004, the base station may receive one or more measurement reports for a first set of frequency resources from the UE. These measurement reports can be used to assess interference levels and help determine suitable time-frequency resources for local communications between the UE and the repeaters.

At operation 1006, the base station allocates time-frequency resources for the local communications between the UE and the one or more repeaters. The allocation of time-frequency resources may be based on the received capability indicator of the maximum number of L₁ spatial layers or the one or more measurement reports. Following this, at operation 1008, the base station determines a multiple-input multiple-output (MIMO) configuration supporting at most L₂ spatial layers for the UE based on the received capability indicator indicating the maximum number of L₁ spatial layers. L₂ is a positive integer and no greater than L₁.

At operation 1010, the base station sends a first indication to the UE, indicating that the UE should start forming a MIMO system with the one or more repeaters. The base station then receives a second indication from the UE at operation 1012, indicating that the MIMO system has been successfully formed. At operation 1014, the base station transmits at most L₂ layers of data signals to the UE for downlink (DL) or receives at most L₂ layers of data signals from the UE for uplink (UL).

In certain configurations, the base station may monitor the capability indicator received from the UE for a number of supporting spatial layers of data signals at operation 1016. The base station adjusts the MIMO configuration for the UE based on the monitored capability indicator at operation 1018. This allows for dynamic adaptation of the MIMO configuration based on the current capabilities of the UE and the repeaters.

The sequence of the operations detailed supra is provided as an example and should not be considered as restrictive. These operations may be reorganized based on different configurations.

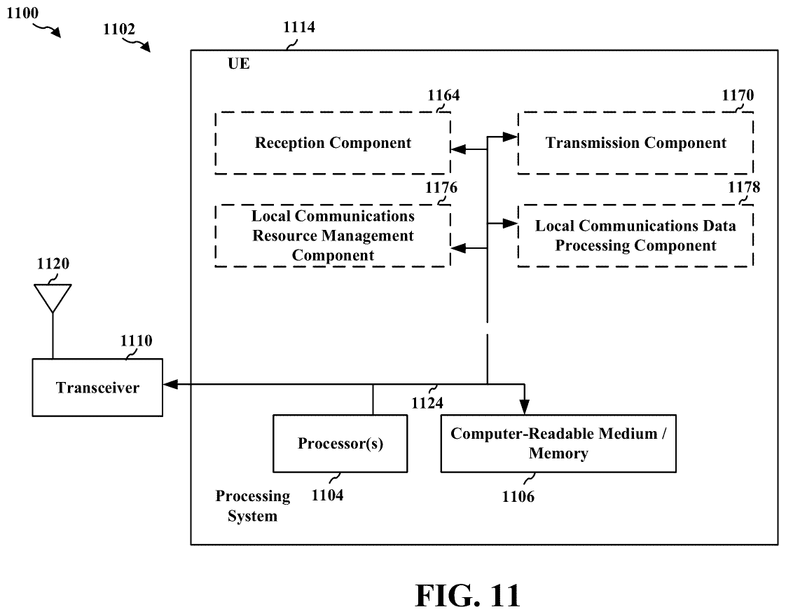

FIG. 11 is a diagram 1100 illustrating an example of a hardware implementation for an apparatus 1102 employing a processing system 1114. The apparatus 1102 may be a UE (e.g., the UE 704). The processing system 1114 may be implemented with a bus architecture, represented generally by a bus 1124. The bus 1124 may include any number of interconnecting buses and bridges depending on the specific application of the processing system 1114 and the overall design constraints. The bus 1124 links together various circuits including one or more processors and/or hardware components, represented by one or more processors 1104, a reception component 1164, a transmission component 1170, a local communications resource management component 1176, a local communications data processing component 1178, and a computer-readable medium/memory 1106. The bus 1124 may also link various other circuits such as timing sources, peripherals, voltage regulators, and power management circuits, etc.

The processing system 1114 may be coupled to a transceiver 1110, which may be one or more of the transceivers 254. The transceiver 1110 is coupled to one or more antennas 1120, which may be the communication antennas 252.

The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1164. In addition, the transceiver 1110 receives information from the processing system 1114, specifically the transmission component 1170, and based on the received information, generates a signal to be applied to the one or more antennas 1120.

The processing system 1114 includes one or more processors 1104 coupled to a computer-readable medium/memory 1106. The one or more processors 1104 are responsible for general processing, including the execution of software stored on the computer-readable medium/memory 1106. The software, when executed by the one or more processors 1104, causes the processing system 1114 to perform the various functions described supra for any particular apparatus. The computer-readable medium/memory 1106 may also be used for storing data that is manipulated by the one or more processors 1104 when executing software. The processing system 1114 further includes at least one of the reception component 1164, the transmission component 1170, the local communications resource management component 1176, and the local communications data processing component 1178. The components may be software components running in the one or more processors 1104, resident/stored in the computer readable medium/memory 1106, one or more hardware components coupled to the one or more processors 1104, or some combination thereof. The processing system 1114 may be a component of the UE 250 and may include the memory 260 and/or at least one of the TX processor 268, the RX processor 256, and the communication processor 259.

In one configuration, the apparatus 1102 for wireless communication includes means for performing each operation/procedure of the UE 704 referring to FIG. 9. The aforementioned means may be one or more of the aforementioned components of the apparatus 1102 and/or the processing system 1114 of the apparatus 1102 configured to perform the functions recited by the aforementioned means.

As described supra, the processing system 1114 may include the TX Processor 268, the RX Processor 256, and the communication processor 259. As such, in one configuration, the aforementioned means may be the TX Processor 268, the RX Processor 256, and the communication processor 259 configured to perform the functions recited by the aforementioned means.

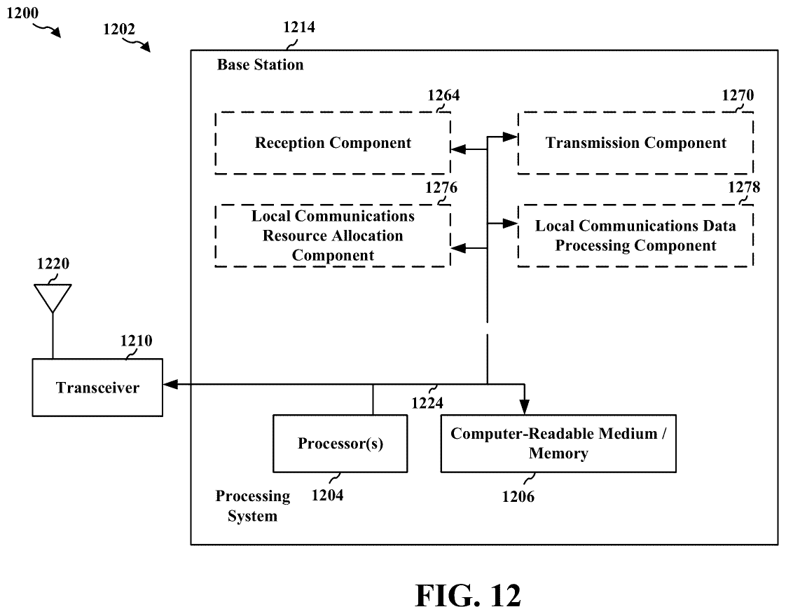

FIG. 12 is a diagram 1200 illustrating an example of a hardware implementation for an apparatus 1202 employing a processing system 1214. The apparatus 1202 may be a base station (e.g., the base station 702). The processing system 1214 may be implemented with a bus architecture, represented generally by a bus 1224. The bus 1224 may include any number of interconnecting buses and bridges depending on the specific application of the processing system 1214 and the overall design constraints. The bus 1224 links together various circuits including one or more processors and/or hardware components, represented by one or more processors 1204, a reception component 1264, a transmission component 1270, a local communications resource allocation component 1276, and a local communications data processing component 1278, and a computer-readable medium/memory 1206. The bus 1224 may also link various other circuits such as timing sources, peripherals, voltage regulators, and power management circuits, etc.

The processing system 1214 may be coupled to a transceiver 1210, which may be one or more of the transceivers 254. The transceiver 1210 is coupled to one or more antennas 1220, which may be the communication antennas 220.

The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1264. In addition, the transceiver 1210 receives information from the processing system 1214, specifically the transmission component 1270, and based on the received information, generates a signal to be applied to the one or more antennas 1220.

The processing system 1214 includes one or more processors 1204 coupled to a computer-readable medium/memory 1206. The one or more processors 1204 are responsible for general processing, including the execution of software stored on the computer-readable medium/memory 1206. The software, when executed by the one or more processors 1204, causes the processing system 1214 to perform the various functions described supra for any particular apparatus. The computer-readable medium/memory 1206 may also be used for storing data that is manipulated by the one or more processors 1204 when executing software. The processing system 1214 further includes at least one of the reception component 1264, the transmission component 1270, the local communications data processing component 1278, and the local communications resource allocation component 1276. The components may be software components running in the one or more processors 1204, resident/stored in the computer readable medium/memory 1206, one or more hardware components coupled to the one or more processors 1204, or some combination thereof. The processing system 1214 may be a component of the base station 210 and may include the memory 276 and/or at least one of the TX processor 216, the RX processor 270, and the controller/processor 275.

In one configuration, the apparatus 1202 for wireless communication includes means for performing each of the operations of FIG. 10. The aforementioned means may be one or more of the aforementioned components of the apparatus 1202 and/or the processing system 1214 of the apparatus 1202 configured to perform the functions recited by the aforementioned means.

As described supra, the processing system 1214 may include the TX Processor 216, the RX Processor 270, and the controller/processor 275. As such, in one configuration, the aforementioned means may be the TX Processor 216, the RX Processor 270, and the controller/processor 275 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving, from a base station, an allocation of time-frequency resources for local communications between the UE and one or more repeaters and a maximum transmission power for the local communications; and
transmitting data signals to the base station or receiving data signals from the base station through the allocated time-frequency resources for local communications.

2. The method of claim 1, wherein the maximum transmission power for the local communications is a maximum transmission power of an uplink transmission of the UE or a maximum transmission power of the one or more repeater for downlink reception at the UE.

3. The method of claim 1, wherein the one or more repeaters amplify received signals in first time-frequency resources and forward the amplified signals in second time-frequency resources, and the first time-frequency resources and the second time-frequency resources are non-overlapping in a frequency domain.

4. The method of claim 1, further comprising:
informing the one or more repeaters of the allocated time frequency resources or the maximum transmission power of the one or more repeater.

5. The method of claim 1, further comprising:
measuring reference signals on a first set of frequency resources to generate one or more measurement reports; and
submitting the one or more measurement reports to the base station.

6. The method of claim 5, wherein the first set of frequency resources includes frequency resources not supported by the base station.

7. The method of claim 1, further comprising:
transmitting, to the base station, a request for time-frequency resources for the local communications.

8. The method of claim 7, wherein the request includes information indicating which devices are to be included in the local communications.

9. The method of claim 1, further comprising:
reporting to the base station a maximum number of spatial layers that the UE can support with the one or more repeaters through local communications.

10. The method of claim 1, wherein the local communications are sidelink communications or for amplifying and forwarding data signals between the UE and the base station.

11. The method of claim 1, further comprising:
receiving, from the base station, a first indication indicating that the UE starts forming a multiple-input multiple-output (MIMO) system with the one or more repeaters; and
sending, to the base station, a second indication indicating that the MIMO system is formed.

12. The method of claim 11, further comprising, sending, to the one or more repeaters a third indication to start forwarding.

13. A method of wireless communication of a base station, comprising:
receiving, from a user equipment (UE), a capability indicator indicating a maximum number of L₁ spatial layers that the UE can support with one or more repeaters through local communications, L₁ being a positive integer;
allocating time-frequency resources for the local communications between the UE and the one or more repeaters;
determining a multiple-input multiple-output (MIMO) configuration supporting at most L₂ spatial layers for the UE based on the received capability indicator indicating the maximum number of L₁ spatial layers, L₂ being a positive integer and no greater than L1; and
transmitting at most L₂ layers of data signals to the UE for downlink (DL) or receiving at most L₂ layers of data signals from the UE for uplink (UL).

14. The method of claim 13, further comprising:
receiving, from the UE, one or more measurement reports for a first set of frequency resources.

15. The method of claim 13, wherein the time-frequency resources are allocated based on the received capability indicator of a maximum number of L₁ spatial layers or the one or more measurement reports.

16. The method of claim 13, further comprising:
monitoring the capability indicator received from the UE for a number of supporting spatial layers of data signals;
adjusting the MIMO configuration for the UE based on the monitored capability indicator.

17. The method of claim 13, further comprising:
sending, to the UE, a first indication indicating that the UE starts forming a MIMO system with the one or more repeaters; and
receiving, from the UE, a second indication indicating that the MIMO system is formed.

18. An apparatus for wireless communication, the apparatus being a user equipment (UE), comprising:
a memory; and
at least one processor coupled to the memory and configured to:
receive, from a base station, an allocation of time-frequency resources for local communications between the UE and one or more repeaters and a maximum transmission power for the local communications; and
transmit data signals to the base station or receive data signals from the base station through the allocated time-frequency resources for local communications.

19. The apparatus of claim 18, wherein the maximum transmission power for the local communications is a maximum transmission power of an uplink transmission of the UE or a maximum transmission power of the one or more repeater for downlink reception at the UE.

20. The apparatus of claim 18, wherein the one or more repeaters amplify received signals in first time-frequency resources and forward the amplified signals in second time-frequency resources, and the first time-frequency resources and the second time-frequency resources are non-overlapping in a frequency domain.
